(19) United States
(12) Patent Application Publication
(10) Pub. No.: US 2026/0229081 A1
(43) Pub. Date: Aug. 6, 2026

(54) BILL HANDLING DEVICE

(71) Applicant: JAPAN CASH MACHINE CO., LTD., Osaka (JP)

(72) Inventors: Tomo TAGUCHI, Osaka (JP); Takeaki TANAKA, Osaka (JP); Thu Van TRAN, Osaka (JP)

(21) Appl. No.: 19/440,753

(22) Filed: Jan. 6, 2026

(30) Foreign Application Priority Data
Jan. 27, 2025 (JP) 2025-011064

(51) Int. Cl. G07D 11/22; G07D 11/16

(52) U.S. Cl. CPC G07D 11/22; G07D 11/16

(57) ABSTRACT

Provided is bill handling device (100) which includes a case (101) having a bill insertion section and a bill discharge section, an identification section (110) for identifying bills, and a conveying roller (104) for transporting bills. The case includes a unit (150) that is detachably attached to the bill discharge section, and at least one component (112L, 112R) that is detachably attached to the bill discharge section at a position facing the unit and has a shape for pushing bills toward the unit.

### TECHNICAL FIELD

The present invention relates to a device for automatically accepting bills.

### BACKGROUND ART

Devices for automatically accepting bills have been known for some time. For example, Japanese Utility Model Laid-Open Publication No. H07-20667 (PTL 1) discloses a banknote handling device. According to PTL 1, the banknote handling device is provided with a resin guide plate that forms a banknote transport path of a transport device, and a guide portion that is integrally formed with the guide plate and protrudes from the guide plate. At least one pair of guide portions is formed on the left and right sides of the transport device, and each guide portion includes an inclined surface that guides parallel side edges of the banknote, which run along approximately the center of the banknote's length, to a height different from the center of the banknote, and a block edge that is provided at the end of the guide portion and extends to a different position relative to the banknote transport path. After passing through the inclined surface of the guide portion in a deformed state, the banknote returns to its initial flat shape due to its own elasticity, forming a surface that intersects with the block edge. After the banknote is placed in the stacker device, even if a fishing line or the like attached to the banknote is pulled, the banknote cannot return to the banknote transport path, preventing fraudulent removal of the banknote.

### CITATION LIST

### Patent Literature

PTL 1: JP.H07-20667.U

### SUMMARY OF INVENTION

### Technical Problem

An object of the present invention is to provide a bill handling device that can reduce the possibility of counted bills flowing back.

### Solution to Problem

According to an aspect of the present invention, there is provided a bill handling device that includes a case having a bill insertion section and a bill discharge section; an identification section for identifying bills; and a conveying roller for transporting the bills. The case includes a unit detachably attached to the bill discharge section; and at least one component detachably attached to the bill discharge section at a position facing the unit and has a shape for pushing the bills toward the unit.

### Advantageous Effects of Invention

As described above, according to the present invention, a bill handling device is provided in which the possibility of counted bills flowing back is reduced.

### BRIEF DESCRIPTION OF THE DRAWINGS

FIG. 1 is a front perspective view showing the overall appearance of a bill handling device according to First Embodiment.

FIG. 2 is a rear perspective view showing the overall appearance of the bill handling device according to the First Embodiment.

FIG. 3 is a right-side cross-sectional view of the bill handling device according to the First Embodiment.

FIG. 4 is a rear perspective view of the bill handling device with the discharge unit according to the First Embodiment removed.

FIG. 5 is a front bottom perspective view of the discharge unit according to the First Embodiment.

FIG. 6 is a left side cross-sectional view showing the positional relationship between the bill detection section and the protrusion according to the First Embodiment.

FIG. 7 is a bottom cross-sectional view showing the positional relationship between the bill detection section and the protrusion according to the First embodiment.

FIG. 8 is an image diagram showing the transition in state of bills passing through the discharge section according to the First Embodiment.

FIG. 9 is a rear perspective view showing the detachable structure of the protrusion component in the discharge section according to the First Embodiment.

FIG. 10 is a front perspective view of the protrusion component according to the First Embodiment.

FIG. 11 is a rear perspective view of a replacement protrusion component according to the First Embodiment.

FIG. 12 is a rear perspective view of a protrusion component according to Third Embodiment.

FIG. 13 is a rear perspective view of a protrusion component according to Fourth Embodiment.

### DESCRIPTION OF EMBODIMENTS

The following describes embodiments of the present invention with reference to the accompanying drawings. In the following description, the same components are denoted by the same reference numerals. Their names and functions are also the same. Accordingly, detailed descriptions thereof of such elements will not be repeated.

### First Embodiment

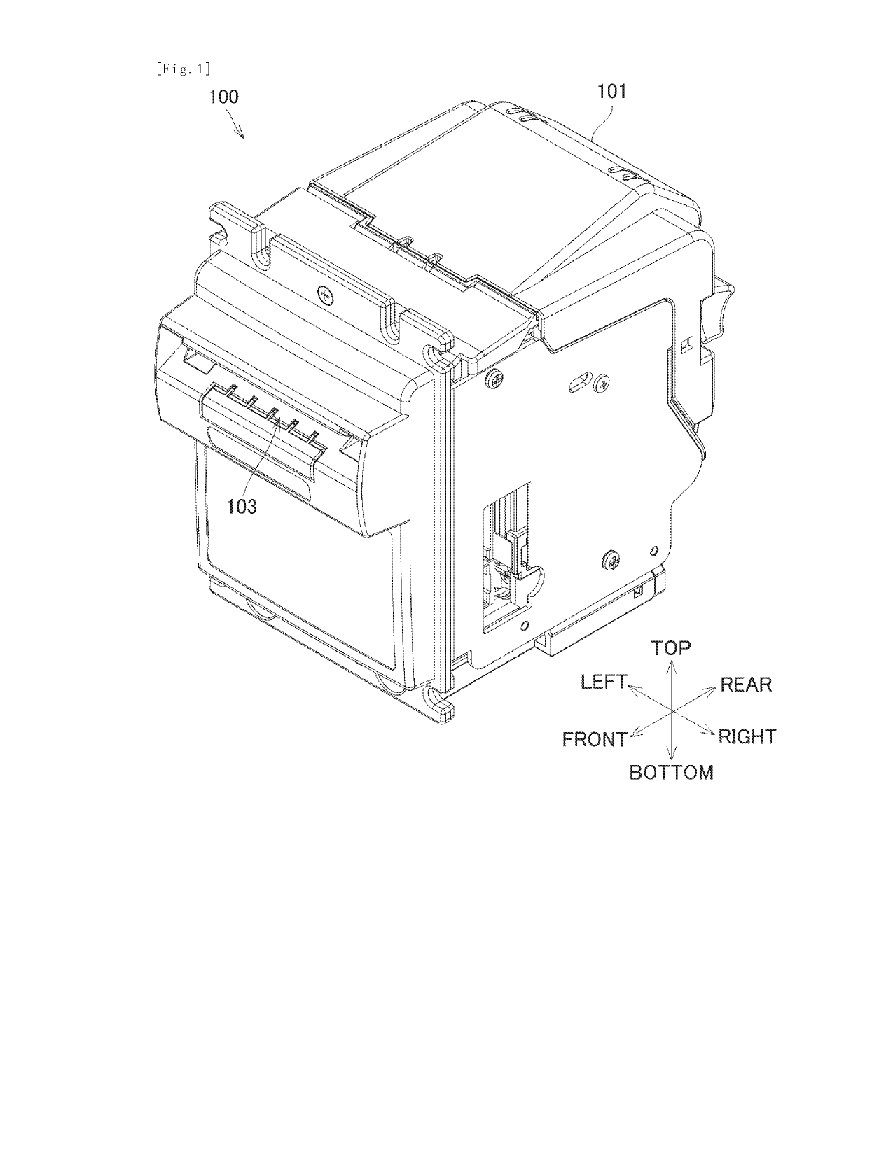

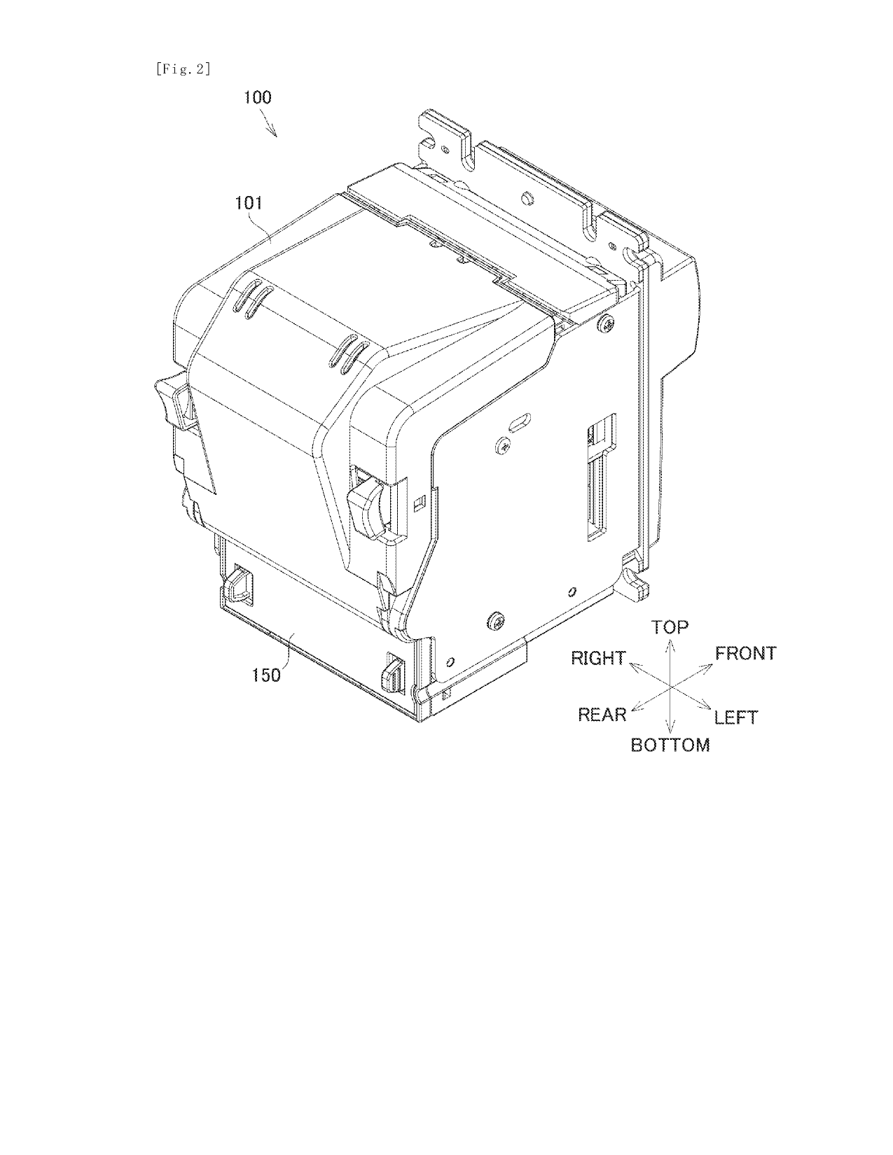

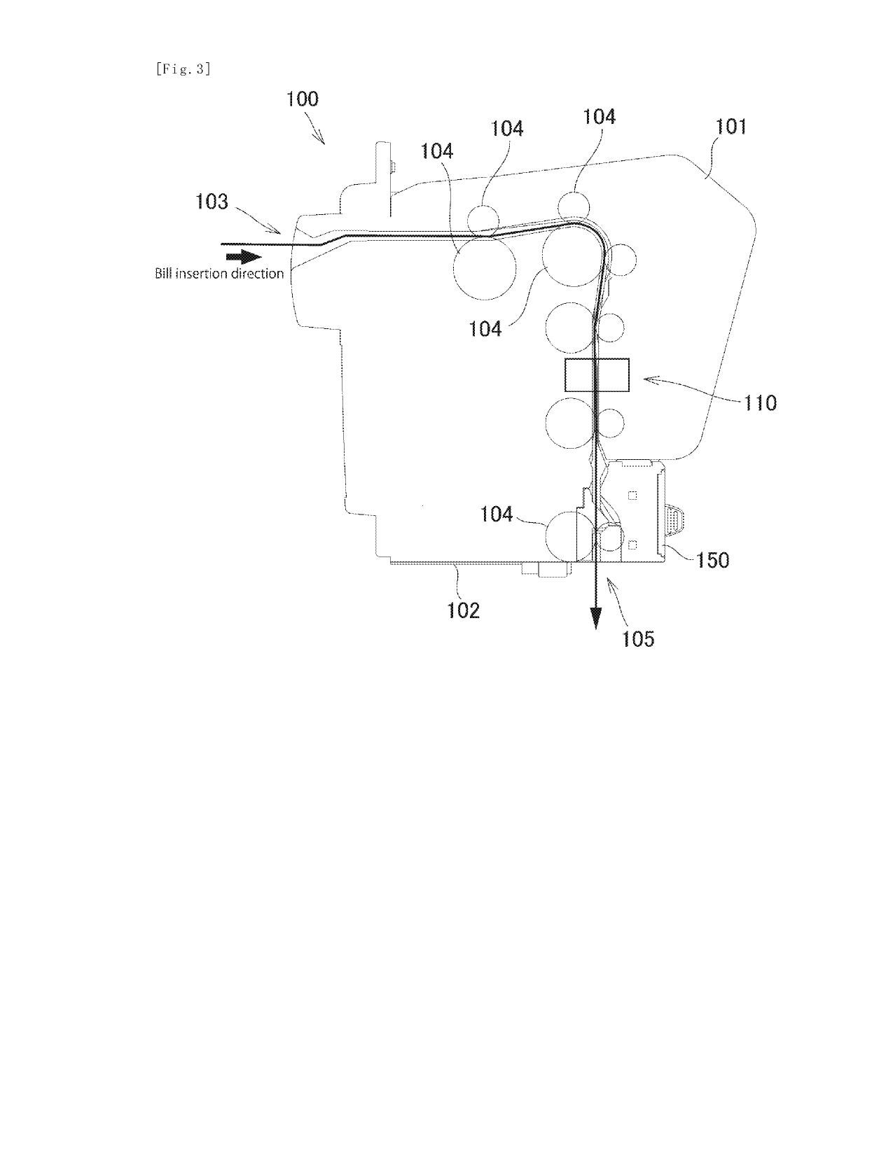

First, the configuration of a bill handling device 100 according to this embodiment will be described with reference to FIG. 1 to FIG. 3. The bill handling device 100 is equipped with a bill identification section 110 for determining the authenticity of bills inside a case 101. The bill handling device 100 uses the bill identification section 110 to determine the denomination of bills received through an insertion port 103 while transporting the bills using conveying rollers 104. After this determination, the bills are counted by denomination and then discharged from a discharge section 105.

In this embodiment, an insertion port 103 is provided at the top of the front face of the bill handling device 100. Bills are transported rearward by a plurality of conveying rollers 104 and then transported downward. They are then discharged downward from a discharge section 105 provided on the bottom face of the bill handling device 100. Below the discharge section 105, there are connected a case for storing bills and a device for stocking them by denomination using a further transport device or the like.

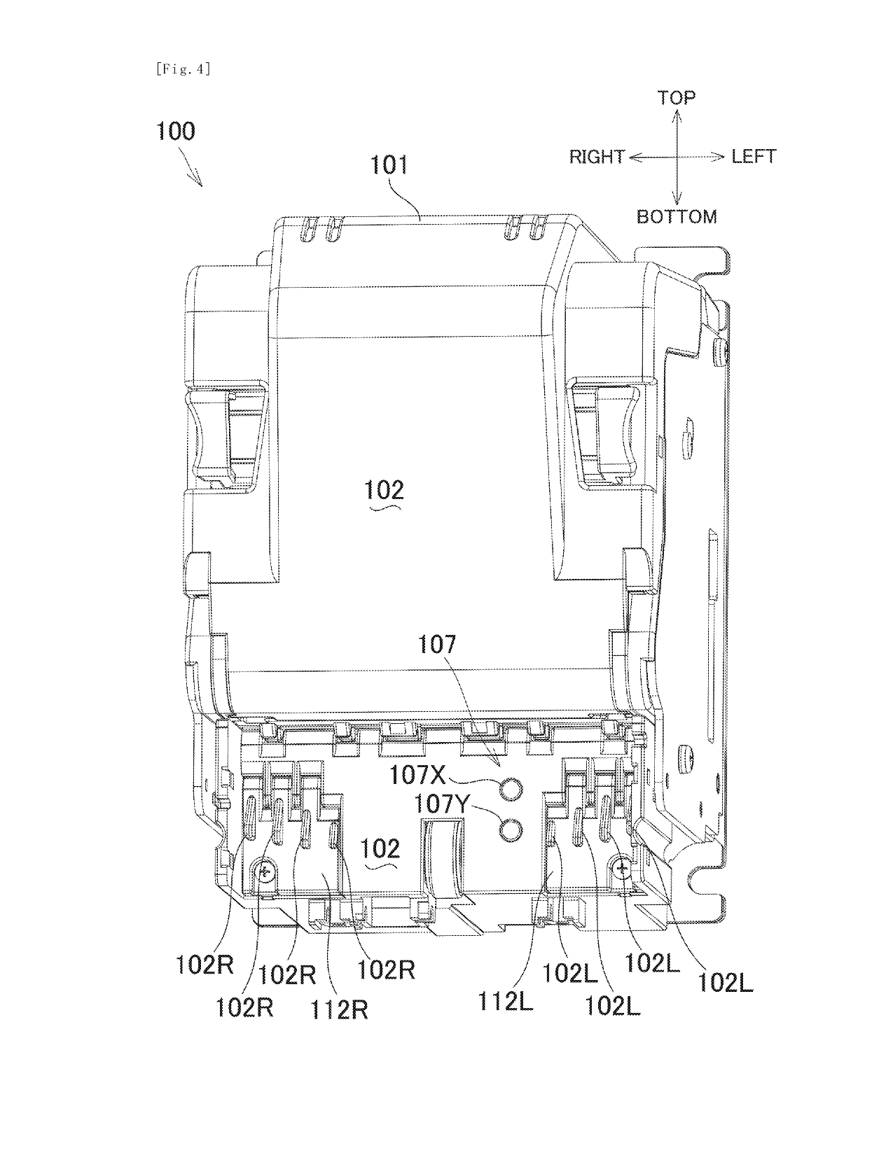

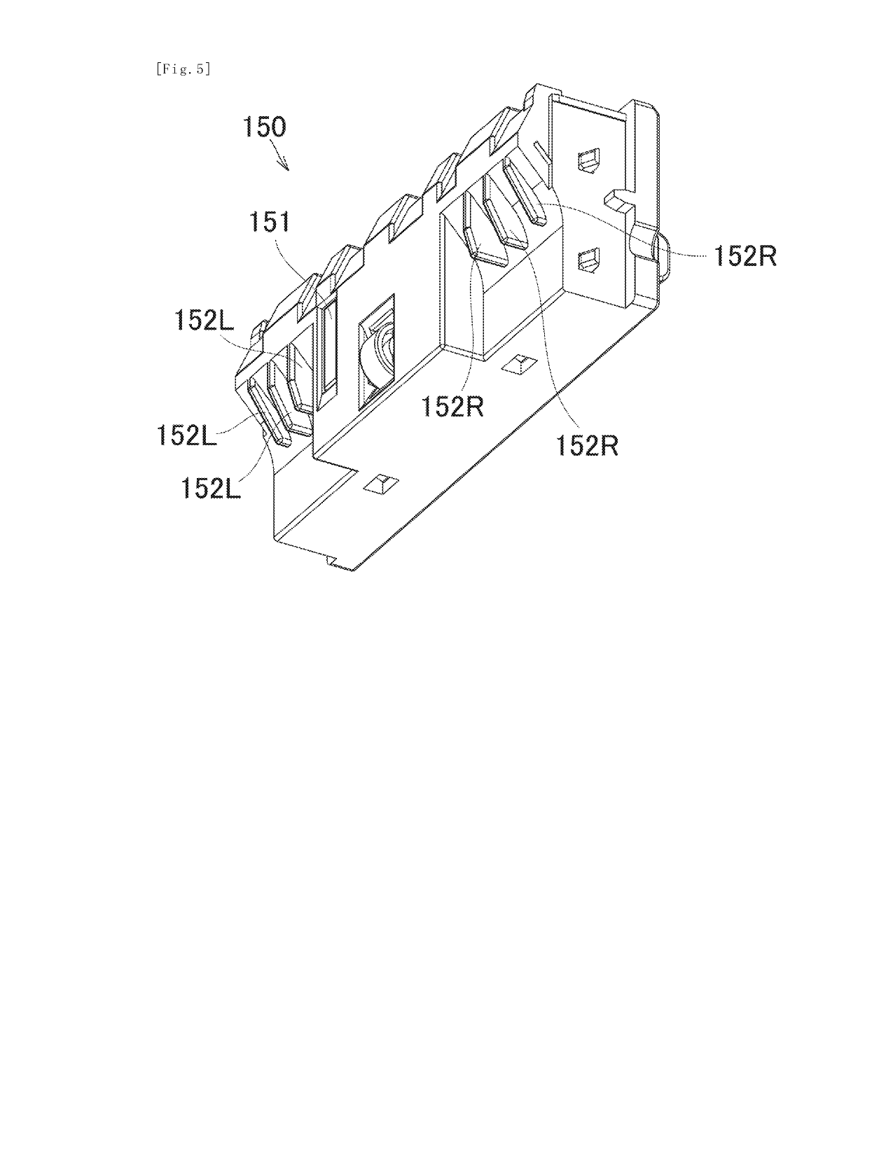

As shown in FIG. 4 and FIG. 5, in this embodiment, a discharge unit 150 constituting the rear part of the discharge section 105 is detachably configured near the discharge section 105. In other words, the discharge section 105 is composed of the main body 102 of the case 101 and the discharge unit 150. In yet other words, the case 101 includes the main body 102 and the discharge unit 150.

A detection section 107 for counting bill currency is provided on the main body 102 side of the case 101. The discharge unit 150 is provided with a mirror 151 that reflects light from the detection section 107.

As a result, light from the light 107X of the detection section 107 is reflected by the mirror 151 and input to the sensor 107Y of the detection section 107. Based on the input from the sensor 107Y of the detection section 107, a control unit (not shown) recognizes that one bill has passed when light is detected again after it has stopped being detected.

In particular, this embodiment is configured so that after a bill has been counted, it does not return from the discharge section 105 and flow back toward the insertion port 103. This configuration is explained below. Also, below, the left side of the bill handling device 100 as viewed from the front will be referred to as "left," and the right side of the bill handling device 100 as viewed from the front will be referred to as "right."

As shown in FIG. 4, a plurality of protrusions 102L, 102L, 102L, 102L, 102R, 102R, 102R, and 102R are provided on the main body 102 side near the discharge section 105.

More specifically, four protrusions 102L, 102L, 102L, and 102L are provided on the discharge section 105 of the main body 102 on the left side when viewed from the front of the device, i.e., on the right side when viewed from the rear of the device. Starting from the center of the device, the lowest protrusion 102L, the second lowest protrusion 102L, the second highest protrusion 102L, and the highest protrusion 102L are provided.

Similarly, four protrusions 102R, 102R, 102R, and 102R are provided on the right side when viewed from the front of the device, i.e., on the left side when viewed from the rear of the device. Starting from the center of the device, the lowest protrusion 102R, the second lowest protrusion 102R, the second highest protrusion 102R, and the highest protrusion 102R are provided.

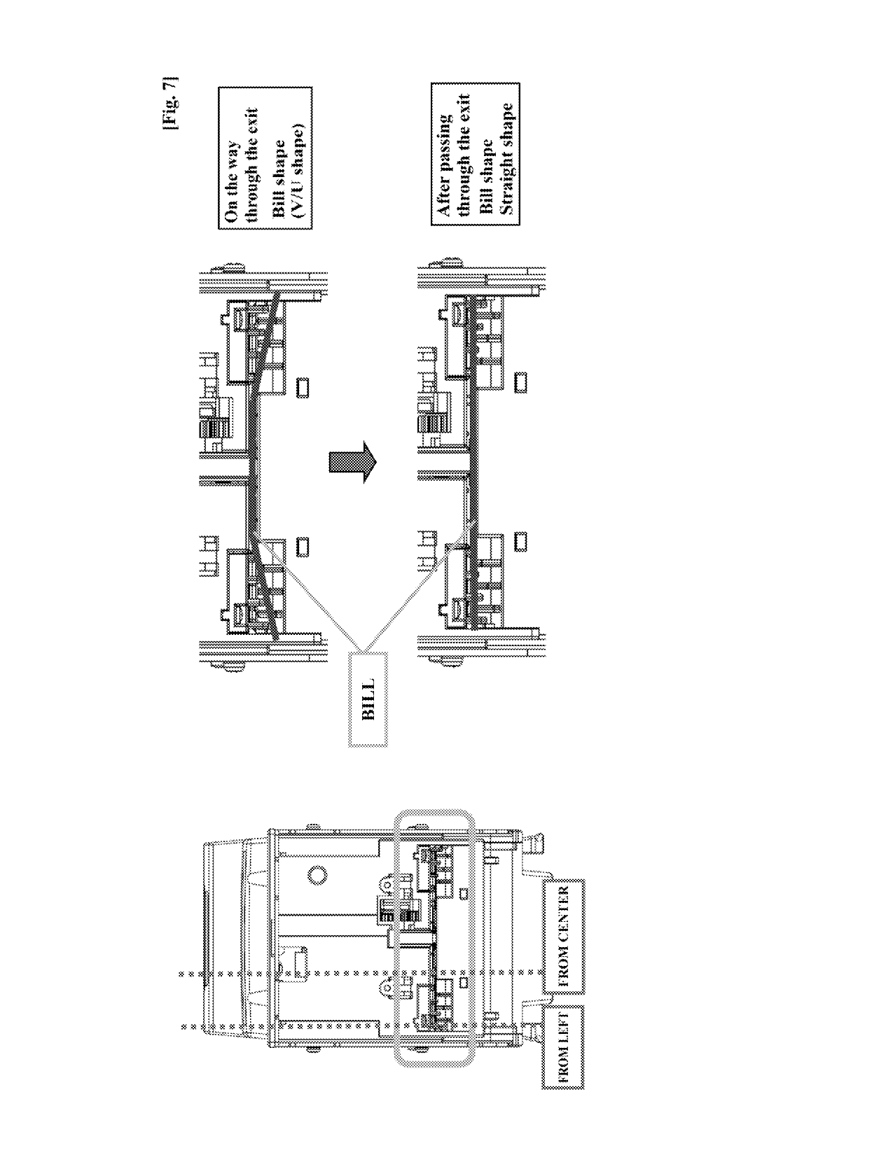

Protrusions are also formed in positions facing the main body 102. That is, as shown in FIG. 7, a plurality of protrusion parts 152L, 152L, 152L, 152R, 152R, and 152R are provided on the front surface of the discharge unit 150 near the discharge section 105.

More specifically, three protrusion parts 152L, 152L, and 152L are provided on the left side of the front surface of the discharge unit 150. Then, from the center of the device, a low protrusion part 152L, a medium protrusion part 152L, and a high protrusion part 152L are provided in this order.

Similarly, three protrusion parts 152R, 152R, and 152R are provided on the right side when viewed from the front of the device. Further, from the center of the device, a low protrusion part 152R, a medium protrusion part 152R, and a high protrusion part 152R are provided in this order.

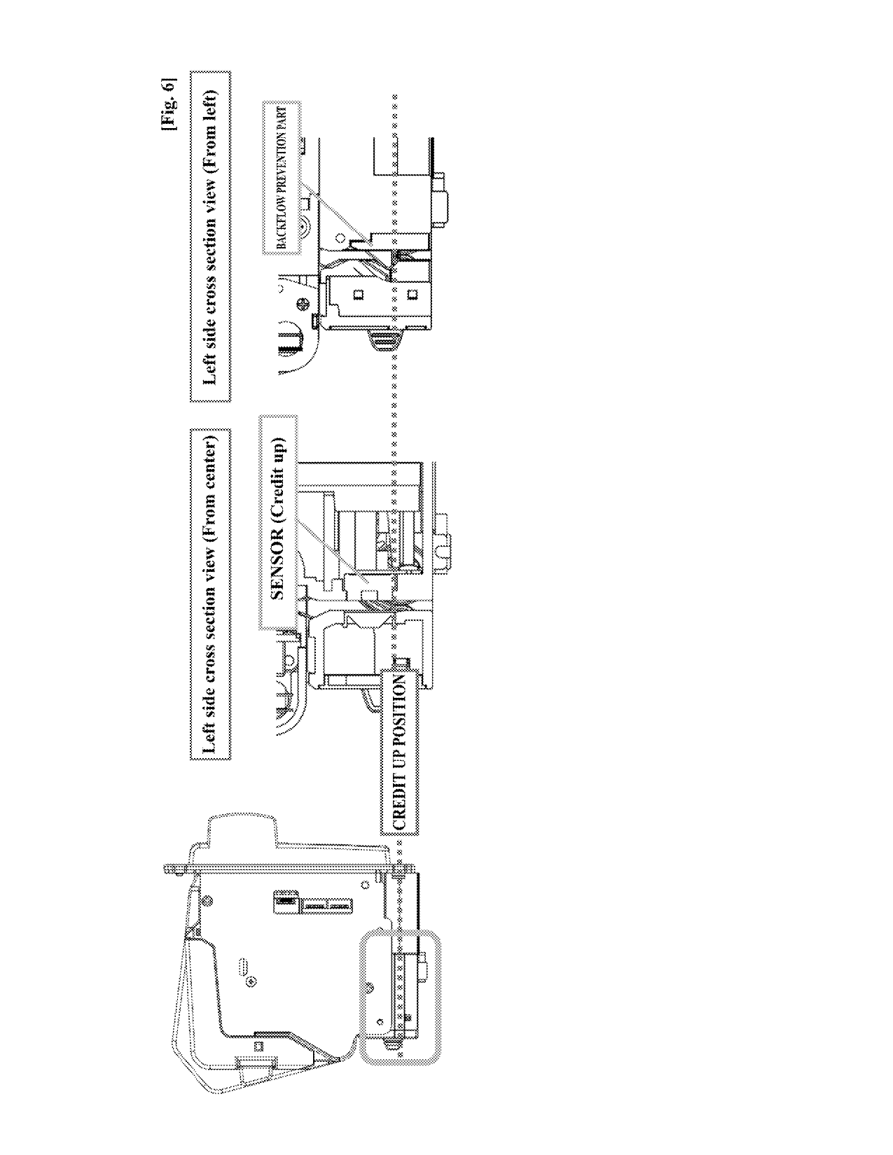

As shown in FIG. 6, the protrusions 102L, 102L, 102L, 102L, 102R, 102R, 102R, 102R on the main body 102 side and the protrusion parts 152L, 152L, 152L, 152R, 152R, 152R on the discharge unit 150 side are provided in the same position as the detection section 107 on the bill conveying route.

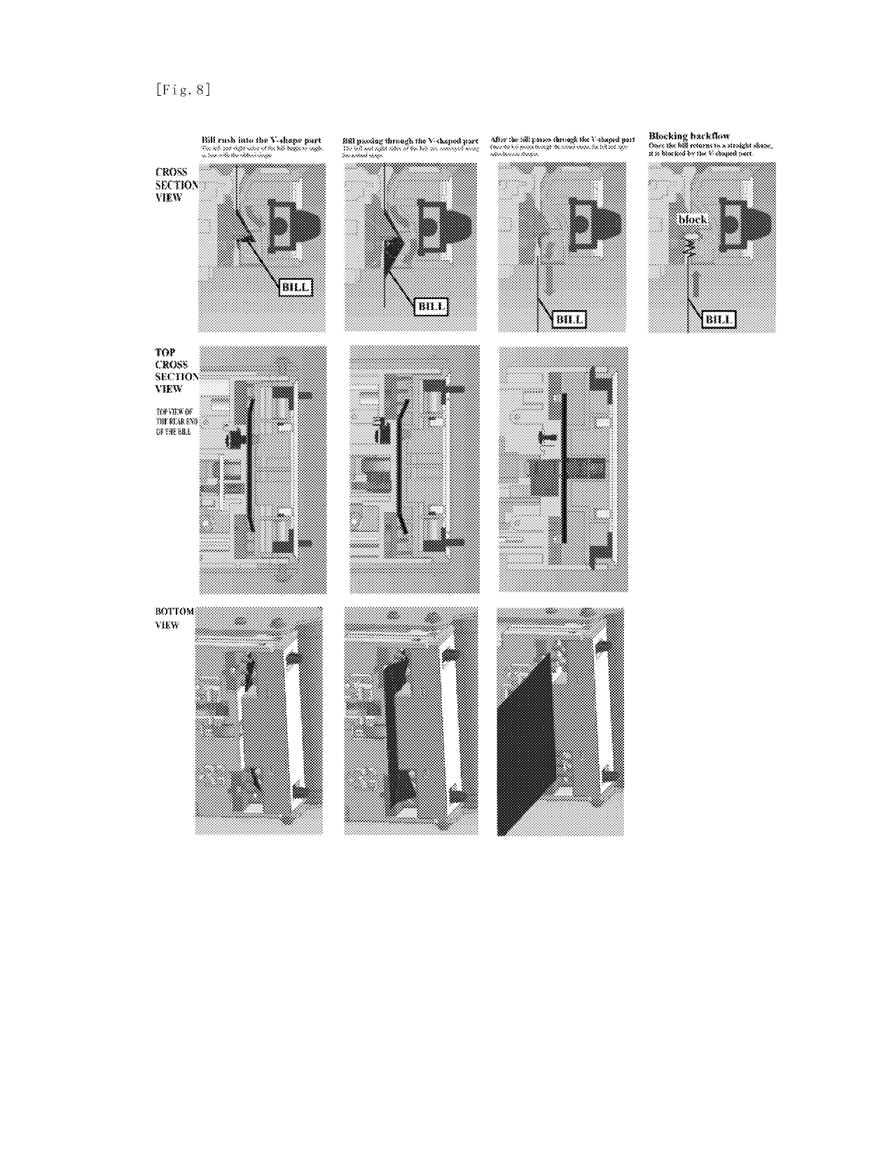

As a result of this configuration, as shown in FIG. 7 and FIG. 8, detected and counted bills are discharged from discharge section 105 in a U-shaped bent state by protrusions 102L, 102L, 102L, 102L, 102R, 102R, 102R, 102R on the main body 102 side and protrusion parts 152L, 152L, 152L, 152R, 152R, 152R on the discharge unit 150 side. When the bills pass through the above-mentioned protrusions, they return to their original flat state due to the elastic force of the bills, and as a result, they cannot flow back between the protrusions 102L, 102L, 102L, 102L, 102R, 102R, 102R, 102R on the main body 102 side and the protrusion parts 152L, 152L, 152L, 152R, 152R, 152R on the discharge unit 150 side.

As such, in this embodiment, protrusions 102L, 102L, 102L, 102L, 102R, 102R, 102R ,102R are provided on the main body 102 side, and protrusion parts 152L, 152L, 152L, 152R, 152R, 152R are also provided on the discharge unit 150 side, thereby it is possible to reduce the possibility of counted bills flowing back more than ever before.

Particularly, in the bill handling device 100 according to this embodiment, the protrusions 102L, 102L, 102L, 102L, 102R, 102R, 102R and 102R on the main body 102 can be freely removed, making it possible to easily realize a more suitable discharge section 105 depending on the conditions below the discharge section 105. This configuration is described in detail below.

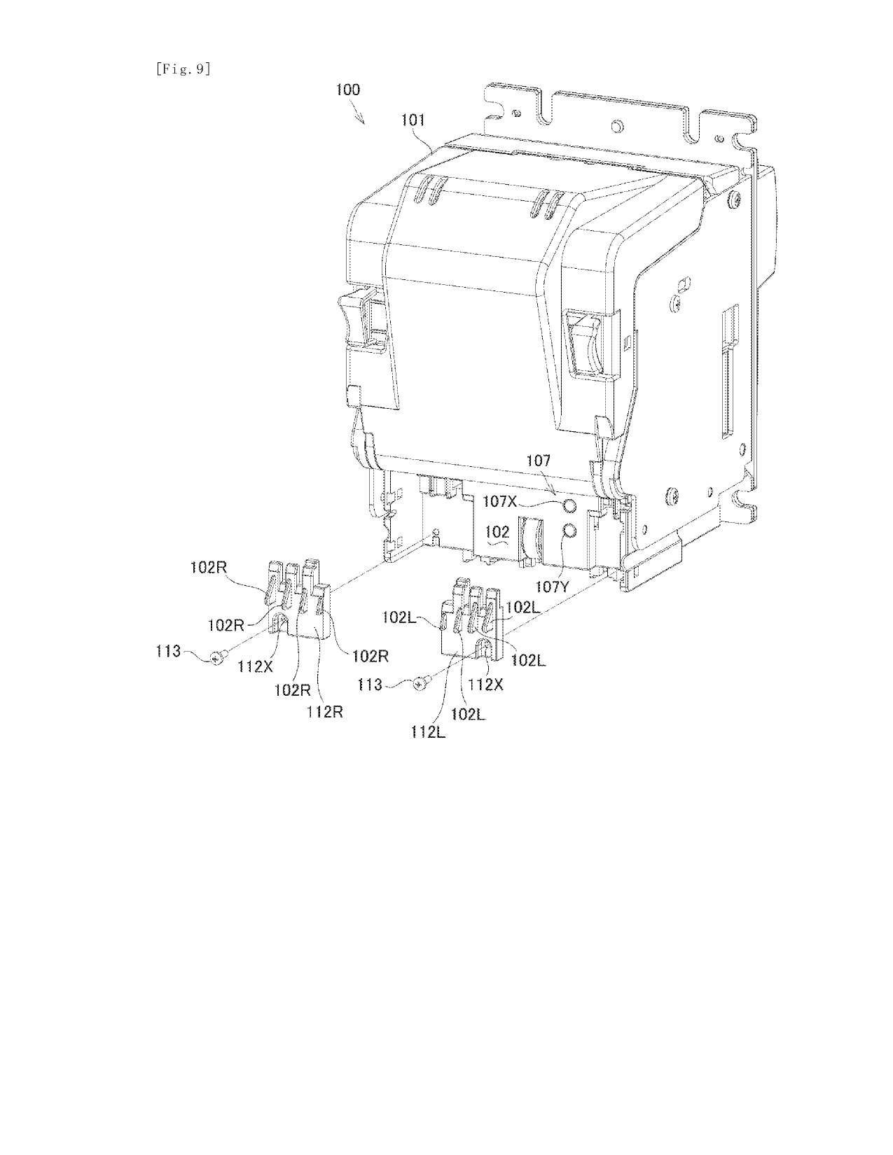

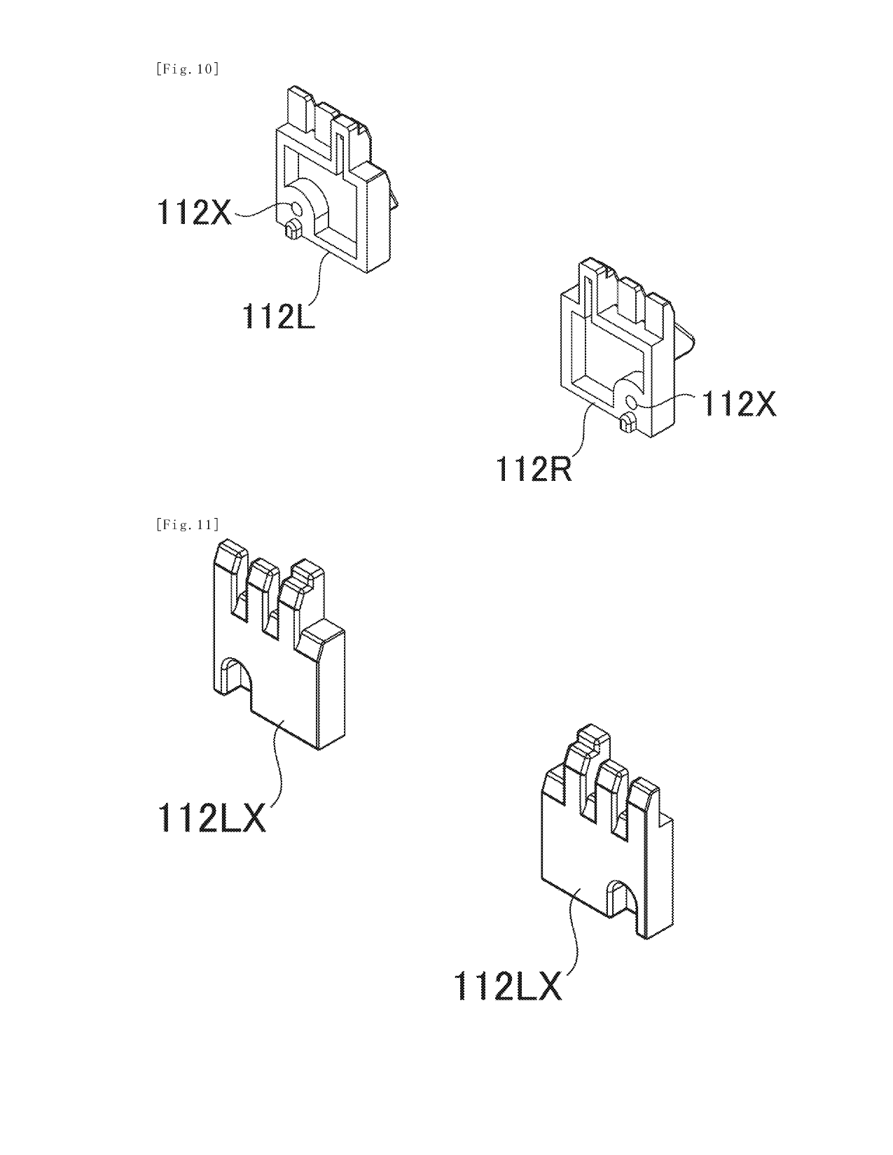

As shown in FIG. 9 and FIG. 10, in this embodiment, protrusion components 112L, 112R are configured to be detachable from the lower rear portion of the main body 102 when the discharge unit 150 is removed. More specifically, the left protrusion component 112L, on which the protrusions 102L, 102L, 102L, and 102L are formed, is detachably attached to the left side of the lower back surface of the main body 102 with a screw 113. The worker passes the screw 113 through the screw hole 112X of the protrusion component 112L and tightens it to the main body 102, thereby fixing the protrusion component 112L to the left side of the lower part of the back surface of the main body 102. Similarly, the right protrusion component 112R, which has protrusions 102R, 102R, 102R, and 102R formed thereon, is detachably attached to the right side of the back surface of the main body 102 with a screw 113. The worker passes the screw 113 through the screw hole 112X of the protrusion component 112R and tightens it to the main body 102, thereby fixing the protrusion component 112R to the right side of the lower part of the back surface of the main body 102.

This allows the components attached to the discharge section 105 to be easily replaced depending on the usage conditions of the bill handling device 100. For example, instead of the protrusion components 112L and 112R, components 112LX and 112RX without protrusions, as shown in FIG. 11, can be attached to the discharge section 105 depending on the type of device connected to the end of the discharge section 105 and the type of bills handled. More specifically, in cases where a large storage space is provided below the discharge section 105 or where bills that have left the discharge section 105 are further transported by conveying rollers, it may be preferable not to require the protrusion components 112L and 112R for preventing backflow and to avoid creating unnecessary resistance.

### Second Embodiment

In the above embodiment, as shown in FIG. 9, multiple protrusions 102L, 102L, 102L, 102L, 102R, 102R, 102R, and 102R are formed on the protrusion components 112L, 112R. However, a single protrusion may be formed on a single protrusion component.

### Third Embodiment

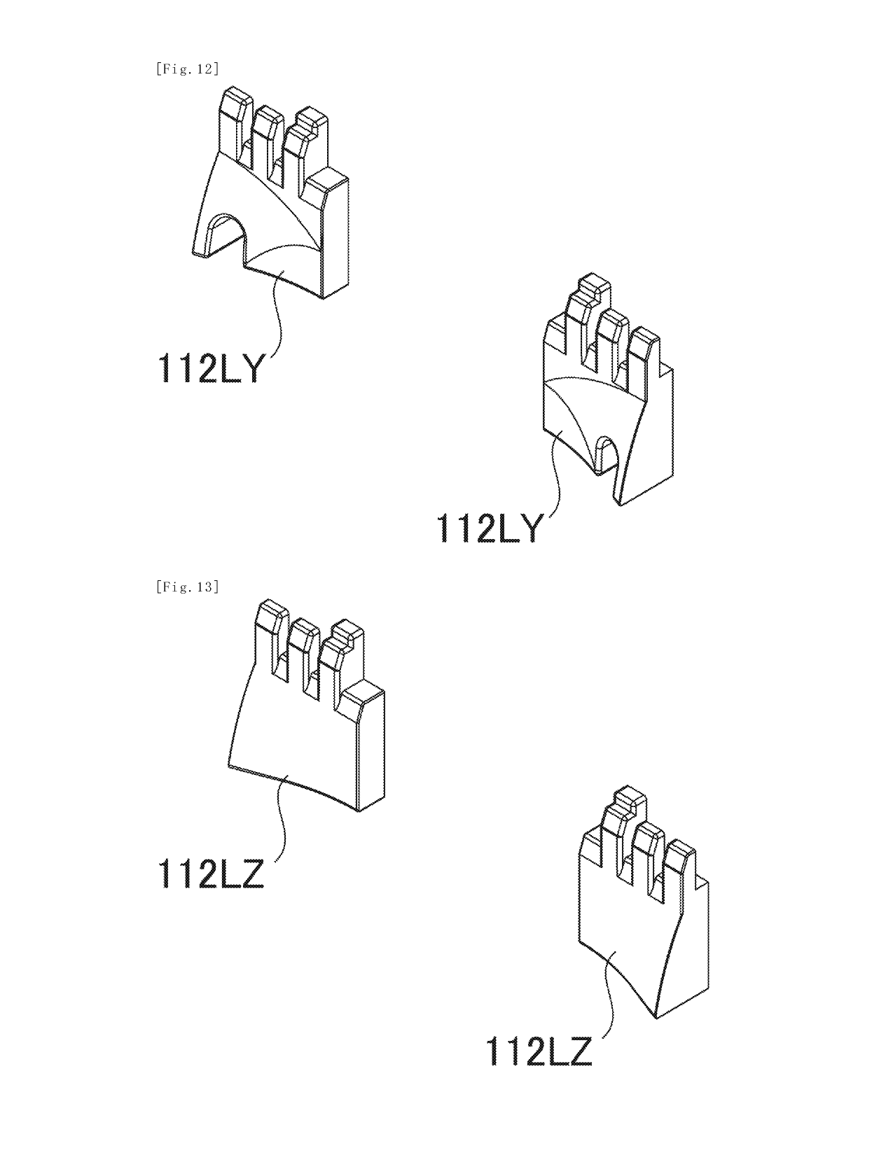

Furthermore, in the above embodiment, as shown in FIG. 9, multiple protrusions 102L, 102L, 102L, 102L, 102R, 102R, 102R, and 102R are formed on the protrusion components 112L, 112R. However, as shown in FIG. 12, the entire surface of protrusion components 112LY, 112RY may be curved. This also allows bills to be output from the discharge section 105 in a bent state, thereby preventing backflow of bills.

### Fourth Embodiment

In the above embodiment, as shown in FIG. 9, the left and right protrusion components 112L, 112R are attached to the rear of the main body 102 from behind using screws 113. However, the present disclosure is not limited to such a configuration. As shown in FIG. 10 and FIG. 13, protrusion components 112LZ, 112RZ may not have screw holes, but may instead have recesses or locking features on their backsides so that they fit into the rear of the main body 102. Alternatively, the protrusion components 112LZ, 112RZ may be hooked onto the underside of the main body 102.

### Fifth Embodiment

In the above embodiment, as shown in FIG. 9, the protrusion components 112L, 112R are attached to both the left and right sides of the discharge section 105. However, they may be configured to be attachable to only one side. Alternatively, the protrusion components may be configured to be attachable to both sides, with the user attaching the protrusion component to only one side.

Alternatively, the protrusion component may be configured to be detachable not only at the left and right ends of the discharge section 105, but also at the center of the discharge section, for example.

Alternatively, the protrusion component may be a member that covers the entire discharge section 105, from the left to the right side.

### Sixth Embodiment

Furthermore, in the above-described embodiment, the protrusion components 112L, 112R on the main body 102 side of the discharge section 105 are configured to be detachable and replaceable. However, the protrusion parts 152L, 152L, 152L, 152R, 152R, and 152R on the discharge unit 150 side may be replaceable. That is, the first component on which the protrusion parts 152L, 152L, 152L are formed may be configured to be detachable on the left side of the front surface of the discharge unit 150, and the second component on which the protrusion parts 152R, 152R, 152R are formed may be configured to be detachable on the right side of the front surface of the discharge unit 150.

### Review

In the above-described embodiment, a bill handling device is provided that includes a case having a bill insertion section and a bill discharge section, a identification section for identifying bills, and a conveying roller for transporting the bills. The case includes a unit that is detachably attached to the bill discharge section, and at least one component that is detachably attached to the bill discharge section at a position facing the unit and has a shape for pushing the bills toward the unit.

Preferably, the at least one component includes a component that is attached to one end of the bill discharge section and has a protrusion for pushing the one end of the bills after counted toward the unit, and a component that is attached to the other end of the bill discharge section and has a protrusion for pushing the other end of the bills after counted toward the unit.

Preferably, the at least one component includes a component that is attached to one end of the bill discharge section and has a slope for pushing the one end of the bills after counted toward the unit, and a component that is attached to the other end of the bill discharge section and has a slope for pushing the other end of the bills after counted toward the unit.

Preferably, the unit has a protrusion or slope facing the at least one component for pushing up the bills toward the at least one component.

Preferably, the part having the protrusion or slope is also configured to be detachable from the unit.

It should be considered that the embodiments disclosed this time are illustrative in all respects and not restrictive. The scope of the present invention is indicated by the scope of the claims rather than the above description, and is intended to include all modifications within the scope and meaning equivalent to the scope of the claims.

### REFERENCE SIGNS LIST

100: Bill Handling Device

101: Case

102: Main Body

102L: Protrusion

102R: Protrusion

103: Insertion Port

104: Conveying Roller

105: Discharge Section

107: Detection Section

107X: Light (Light Emitting Side of Sensor)

107Y: Sensor (Light Receiving Side of Sensor)

110: Bill Identification Section

112L: Protrusion Component

112R: Protrusion Component

112LX: Component

112RX: Component

112LY: Protrusion Component

112RY: Protrusion Component

112LZ: Protrusion Component

112RZ: Protrusion Component

113: Screw

150: Discharge Unit

151: Mirror

152L: Protrusion Part

152R: Protrusion Part

What is claimed is:

1. A bill handling device comprising:
a case having a bill insertion section and a bill discharge section;
an identification section for identifying bills;
and a conveying roller for transporting the bills;
wherein the case includes a unit detachably attached to the bill discharge section; and
at least one component detachably attached to the bill discharge section at a position facing the unit and has a shape for pushing the bills toward the unit.

2. The bill handling device according to claim 1, wherein the at least one component includes:
a component attached to one end of the bill discharge section and having a protrusion for pushing the one end of the bills after counted toward the unit; and
a component attached to the other end of the bill discharge section and having a protrusion for pushing the other end of the bills after counted toward the unit.

3. The bill handling device according to claim 1, wherein the at least one component includes:
a component attached to one end of the bill discharge section and having a slope for pushing the one end of the bills after counted toward the unit; and
a component attached to the other end of the bill discharge section and having a slope for pushing the other end of the bills after counted toward the unit.

4. The bill handling device according to claim 1, wherein the unit has a protrusion or slope facing the at least one component for pushing the bills toward the at least one component.

5. The bill handling device according to claim 4, wherein the part having the protrusion or slope is also configured to be detachable from the unit.
